(19) United States
(12) Patent Application Publication
(10) Pub. No.: US 2024/0119299 A1
(43) Pub. Date: Apr. 11, 2024

(54) APPARATUS FOR DETERMINING THE NUMBER OF LAYERS OF GRAPH NEURAL NETWORK BY USING REINFORCEMENT LEARNING MODEL, METHOD FOR DETERMINING THE NUMBER OF LAYERS OF GRAPH NEURAL NETWORK BY USING REINFORCEMENT LEARNING MODEL, AND RECORDING MEDIUM STORING INSTRUCTIONS TO PERFORM METHOD FOR DETERMINING THE NUMBER OF LAYERS OF GRAPH NEURAL NETWORK BY USING REINFORCEMENT LEARNING MODEL

(71) Applicant: Research & Business Foundation SUNGKYUNKWAN UNIVERSITY, Suwon-si (KR)

(72) Inventors: Hogun PARK, Suwon-si (KR); Hee Soo JUNG, Suwon-si (KR)

(73) Assignee: Research & Business Foundation SUNGKYUNKWAN UNIVERSITY, Suwon-si (KR)

(21) Appl. No.: 18/090,685

(22) Filed: Dec. 29, 2022

(30) Foreign Application Priority Data
Oct. 11, 2022 (KR) 10-2022-0129721

(51) Int. Cl. G06N 3/092

(52) U.S. Cl. CPC G06N 3/092

(57) ABSTRACT

In accordance with an aspect of the present disclosure, there is provided an apparatus for determining a number of layers may comprise a data manager configured to obtain a graph structure including information between nodes; a first controller configured to control a reinforcement learning model designed to set the graph structure as an environment of reinforcement learning, set any one of nodes included in the graph structure as a state of reinforcement learning, and set a number of branches causing a highest expected value for a reward of reinforcement learning from any node as an action of reinforcement learning; a storage configured to store the number of branches determined by the reinforcement learning model as an action for a predetermined node input to the reinforcement learning model; and a second controller configured to apply the same number of layers for extracting an embedding of the predetermined node as the stored number of branches in a graph neural network designed based on the graph structure.

### TECHNICAL FIELD

The present disclosure relates to an apparatus and method for determining the number of layers of a graph neural network using a reinforcement learning model, a computer readable recording medium, and a computer program.

This work was supported by National Research Foundation of Korea funded by the Korea government (MSIT) ([Project unique No.: 1711157583; Project No.: 2021R1C1C1005407; R&D project: Basic Research Projects; and Research Project Title: Development of communication/computing-integrated revolutionary technologies for superintelligent services], and [Project unique No.: 1711158840; Project No.: 2021M3H4A1A02056037; R&D project: Nano Material Technology Development Projects; and Research Project Title: Development of stress visualization and quantification durability evaluation platform based on stimulus-sensitive polymer complex), and Institute of Information & communications Technology Planning & Evaluation (IITP) grant funded by Korea government (MSIT) (Project unique No.: 1711153024; Project No.: 2019-0-00421-004; R&D project: Information Communication Broadcasting Innovative Talent Development Project; and Research Project Title: Artificial Intelligence Graduate School Program), and National Information & Technology Industry Promotion Agency (NIPA) grant funded by the Korea government (MSIT) (Project unique No.: 1711171054; Project No.: S0254-22-1001; R&D project: Healthcare AI convergence research and development; and Research Project Title: Development of Brain-body interface technology using AI-based multi-sensing).

### BACKGROUND

As personal electronic devices such as smartphones are spread all over the world and high-speed communication develops, new data is being created day by day. The amount of various types of data generated in this way exponentially increases.

Considering the foregoing, methods of recommending an item suitable for a corresponding user among a vast amount of items (e.g., content such as video, music, and products) based on user information are being used.

In particular, a graph neural network is used for such recommendation systems. Such a graph neural network can model high-order connection information between a user and an item by collecting node information based on a graph structure.

### SUMMARY

Since the graph neural network does not consider heterogeneous characteristics of users and items in a manner of learning the graph structure itself, it cannot additionally consider the heterogeneous characteristics of users and items.

In addition, in the graph neural network, training is performed based on an embedding output when node information of the graph structure to be trained passes through layers. The number of layers applied to the graph neural network is uniformly applied according to a designer's choice, and thus it is difficult to derive embedding by designing the number of layers differently according to characteristics of each node of the graph structure.

Furthermore, since users and items, which are nodes included in the graph structure, have heterogeneous properties, the performance of the neural network can be further improved if learning separately considering characteristics of respective users and items can be performed.

An object of the present disclosure is to propose a technology for considering heterogeneous characteristics of users and items included in a graph structure using a reinforcement learning model and adaptively determining the number of layers of a graph neural network necessary to derive the optimal embedding for each node included in the graph structure to be trained.

However, the object of the present disclosure is not limited to the aforementioned one, and other objects that are not mentioned can be clearly understood by those skilled in the art from the description below.

In accordance with an aspect of the present disclosure, there is provided an apparatus for determining a number of layers, the apparatus may comprise: a data manager configured to obtain a graph structure including information between nodes; a first controller configured to control a reinforcement learning model designed to set the graph structure as an environment of reinforcement learning, set any one of nodes included in the graph structure as a state of reinforcement learning, and set a number of branches causing a highest expected value for a reward of reinforcement learning from any node as an action of reinforcement learning; a storage configured to store the number of branches determined by the reinforcement learning model as an action for a predetermined node input to the reinforcement learning model; and a second controller configured to apply the same number of layers for extracting an embedding of the predetermined node as the stored number of branches in a graph neural network designed based on the graph structure.

In addition, the graph structure may include user nodes and item nodes, and the information between nodes includes purchase information indicating whether or not users of user nodes purchase items of item nodes.

In addition, the graph structure may include information on users, items, and entities of a knowledge graph along with the knowledge graph.

In addition, the reinforcement learning model may include: a first reinforcement learning model designed to set the graph structure as an environment of reinforcement learning, set any one of the user nodes as a state of reinforcement learning, and set a number of branches causing a highest expected value for a reward of reinforcement learning from any user node as an action of reinforcement learning; and a second reinforcement learning model designed to set the graph structure as an environment of reinforcement learning, set any one of the item nodes as a state of reinforcement learning, and set a number of branches causing a highest expected value for a reward of reinforcement learning from any item node as an action of reinforcement learning.

In addition, the storage may store: a first tuple list including an identifier corresponding to each of first to (n+1)-th user nodes based on the user nodes and the number of branches corresponding to each of the first to (n+1)-th user nodes in a case where the first reinforcement learning model extracts the number of (n+1)-th branches for the (n+1)-th user node reached from an n-th user node through branching by the number of n-th branches in the graph structure based on the n-th user node (n being a natural number) input to the first reinforcement learning model and the number of n-th branches determined by the first reinforcement learning model for the n-th user node; and a second tuple list including an identifier corresponding to each of first to (n+1)-th item nodes based on the item nodes and the number of branches corresponding to each of the first to (n+1)-th item nodes in a case where the second reinforcement learning model extracts the number of (n+1)-th branches for the (n+1)-th item node reached from an n-th item node through branching by the number of n-th branches in the graph structure based on the n-th item node (n being a natural number) input to the second reinforcement learning model and the number of n-th branches determined by the second reinforcement learning model for the n-th item node.

In addition, the first controller may set a first reward of the first reinforcement learning model based on information on item nodes included in the second tuple list and set a second reward of the second reinforcement learning model based on information on user nodes included in the first tuple list.

In addition, first reward applied to a first input node of the first reinforcement learning model may include a function for assigning a higher score as an embedding distance between a positive node, which has purchase information regarding the first input node among the item nodes included in the second tuple list, and the first input node is closer and a function for deducting a higher score as an embedding distance between a negative node, which has no purchase information regarding the first input node among the item nodes included in the second tuple list, and the first input node is closer, and wherein the second reward applied to a second input node of the second reinforcement learning model includes a function for assigning a higher score as an embedding distance between a positive node, which has purchase information regarding the second input node among the user nodes included in the first tuple list, and the second input node is closer and a function for deducting a higher score as an embedding distance between a negative node, which has no purchase information regarding the second input node among the user nodes included in the first tuple list, and the second input node is closer.

In addition, the first controller may set, as the first reward, a difference between an inner product of an embedding vector of the first input node and an embedding vector of a positive node in the second tuple list and an inner product of the embedding vector of the first input node and an embedding vector of a negative node in the second tuple list, and set, as the second reward, a difference between an inner product of an embedding vector of the second input node and an embedding vector of a positive node in the first tuple list and an inner product of the embedding vector of the second input node and an embedding vector of a negative node in the first tuple list.

In addition, the first controller may set the first reward by sampling the same number of positive nodes and negative nodes in the second tuple list, and set the second reward by sampling the same number of positive nodes and negative nodes in the first tuple list.

In addition, an expected value may be set as the sum of rewards received from a specific node to nodes reached by branching from the specific node a predetermined number of times base on the first reward or the second reward.

In addition, the second controller may train the graph neural network based on the first tuple list or the second tuple list by setting the same number of layers of the graph neural network as the number of k-th branches when a k-th node (k being a natural number equal to or greater than 1 and equal to or less than n+1) among tuples included in the first tuple list or the second tuple list is used for learning, and using an embedding that has finally passed the number of layers from the k-th node as a final embedding of the k-th node.

In accordance with an aspect of the present disclosure, there is provided a method of determining a number of layers, performed by an apparatus for determining a number of layers, the method may comprise: obtaining a graph structure including information between nodes; controlling a reinforcement learning model designed to set the graph structure as an environment of reinforcement learning, set any one of nodes included in the graph structure as a state of reinforcement learning, and set a number of branches causing a highest expected value for a reward of reinforcement learning from any node as an action of reinforcement learning; storing the number of branches determined by the reinforcement learning model as an action for a predetermined node input to the reinforcement learning model; and applying the same number of layers for extracting an embedding of the predetermined node as the stored number of branches in a graph neural network designed based on the graph structure.

In addition, the graph structure may include user nodes and item nodes, and the information between nodes includes purchase information indicating whether or not users of user nodes purchase items of item nodes.

In addition, the graph structure may include information on users, items, and entities of a knowledge graph along with the knowledge graph.

In addition, the reinforcement learning model may include: a first reinforcement learning model designed to set the graph structure as an environment of reinforcement learning, set any one of the user nodes as a state of reinforcement learning, and set a number of branches causing a highest expected value for a reward of reinforcement learning from any user node as an action of reinforcement learning; and a second reinforcement learning model designed to set the graph structure as an environment of reinforcement learning, set any one of the item nodes as a state of reinforcement learning, and set a number of branches causing a highest expected value for a reward of reinforcement learning from any item node as an action of reinforcement learning.

In addition, the storing may include: storing a first tuple list including an identifier corresponding to each of first to (n+1)-th user nodes based on the user nodes and the number of branches corresponding to each of the first to (n+1)-th user nodes in a case where the first reinforcement learning model extracts the number of (n+1)-th branches for the (n+1)-th user node reached from an n-th user node through branching by the number of n-th branches in the graph structure based on the n-th user node (n being a natural number) input to the first reinforcement learning model and the number of n-th branches determined by the first reinforcement learning model for the n-th user node; and storing a second tuple list including an identifier corresponding to each of first to (n+1)-th item nodes based on the item nodes and the number of branches corresponding to each of the first to (n+1)-th item nodes in a case where the second reinforcement learning model extracts the number of (n+1)-th branches for the (n+1)-th item node reached from an n-th item node through branching by the number of n-th branches in the graph structure based on the n-th item node (n being a natural number) input to the second reinforcement learning model and the number of n-th branches determined by the second reinforcement learning model for the n-th item node.

In addition, the controlling may include: setting a first reward of the first reinforcement learning model based on information on item nodes included in the second tuple list; and setting a second reward of the second reinforcement learning model based on information on user nodes included in the first tuple list.

In addition, the first reward applied to a first input node of the first reinforcement learning model may include a function for assigning a higher score as an embedding distance between a positive node, which has purchase information regarding the first input node among the item nodes included in the second tuple list, and the first input node is closer and a function for deducting a higher score as an embedding distance between a negative node, which has no purchase information regarding the first input node among the item nodes included in the second tuple list, and the first input node is closer, and wherein the second reward applied to a second input node of the second reinforcement learning model includes a function for assigning a higher score as an embedding distance between a positive node, which has purchase information regarding the second input node among the user nodes included in the first tuple list, and the second input node is closer and a function for deducting a higher score as an embedding distance between a negative node, which has no purchase information regarding the second input node among the user nodes included in the first tuple list, and the second input node is closer.

In addition, the controlling may include: setting, as the first reward, a difference between an inner product of an embedding vector of the first input node and an embedding vector of a positive node in the second tuple list and an inner product of the embedding vector of the first input node and an embedding vector of a negative node in the second tuple list; and setting, as the second reward, a difference between an inner product of an embedding vector of the second input node and an embedding vector of a positive node in the first tuple list and an inner product of the embedding vector of the second input node and an embedding vector of a negative node in the first tuple list.

In addition, the controlling may include: setting the first reward by sampling the same number of positive nodes and negative nodes in the second tuple list; and setting the second reward by sampling the same number of positive nodes and negative nodes in the first tuple list.

In addition, an expected value may be set as the sum of rewards received from a specific node to nodes reached by branching from the specific node a predetermined number of times base on the first reward or the second reward.

In addition, the applying may include training the graph neural network based on the first tuple list or the second tuple list by setting the same number of layers of the graph neural network as the number of k-th branches when a k-th node (k being a natural number equal to or greater than 1 and equal to or less than n+1) among tuples included in the first tuple list or the second tuple list is used for learning, and using an embedding that has finally passed the number of layers from the k-th node as a final embedding of the k-th node.

In accordance with another aspect of the present disclosure, there is provided a non-transitory computer-readable storage medium storing computer executable instructions, wherein the instructions, when executed by a processor, cause the processor to perform a method of determining a number of layers, the method may comprise: obtaining a graph structure including information between nodes; controlling a reinforcement learning model designed to set the graph structure as an environment of reinforcement learning, set any one of nodes included in the graph structure as a state of reinforcement learning, and set a number of branches causing a highest expected value for a reward of reinforcement learning from any node as an action of reinforcement learning; storing the number of branches determined by the reinforcement learning model as an action for a predetermined node input to the reinforcement learning model; and applying the same number of layers for extracting an embedding of the predetermined node as the stored number of branches in a graph neural network designed based on the graph structure.

In accordance with another aspect of the present disclosure, there is provided a computer program stored in a non-transitory computer-readable storage medium including computer executable instructions, wherein the instructions, when executed by a processor, cause the processor to perform a method of determining a number of layers, the method may comprise: obtaining a graph structure including information between nodes; controlling a reinforcement learning model designed to set the graph structure as an environment of reinforcement learning, set any one of nodes included in the graph structure as a state of reinforcement learning, and set a number of branches causing a highest expected value for a reward of reinforcement learning from any node as an action of reinforcement learning; storing the number of branches determined by the reinforcement learning model as an action for a predetermined node input to the reinforcement learning model; and applying the same number of layers for extracting an embedding of the predetermined node as the stored number of branches in a graph neural network designed based on the graph structure.

A graph neural network according to an embodiment of the present disclosure operates in association with a first reinforcement learning model for determining an optimal number of layers to be applied to derive embedding of each user node and a second reinforcement learning model for determining an optimal number of layers to be applied to derive embedding of each item node such that the number of required layers of the graph neural network is adaptively determined according to each node included in the graph structure, and thus optimal embedding according to characteristics of each node can be derived.

In addition, since rewards are determined based on item information for the first reinforcement learning model for determining the number of layers of a user node, and rewards are determined based on user information for the second reinforcement learning model for determining the number of layers of an item node, learning can be performed in consideration of heterogeneous characteristics of users and items, and thus the performance can be improved beyond the limitations of a recommendation system using a graph neural network alone.

The effects that can be obtained from the present disclosure are not limited to the aforementioned effects, and other effects that are not mentioned can be clearly understood by those skilled in the art from the description below.

### BRIEF DESCRIPTION OF THE DRAWINGS

FIG. 1 is a functional block diagram of an apparatus for determining the number of layers according to an embodiment of the present disclosure.

FIG. 2 is an exemplary diagram for describing a learning process of a first reinforcement learning model, a second reinforcement learning model, and a graph neural network according to an embodiment of the present disclosure.

FIG. 3 is an exemplary diagram of an operation of searching for a node in a next state from a node in a current state based on the number of branches output as an action by a reinforcement learning model according to an embodiment of the present disclosure.

FIG. 4 is a flowchart of a method of determining the number of layers performed by the apparatus for determining the number of layers according to an embodiment of the present disclosure.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

Hereinafter, a term such as a “unit” or a “portion” used in the specification means an entity for performing a certain role, which is configured to combine at least one of software component and a hardware component.

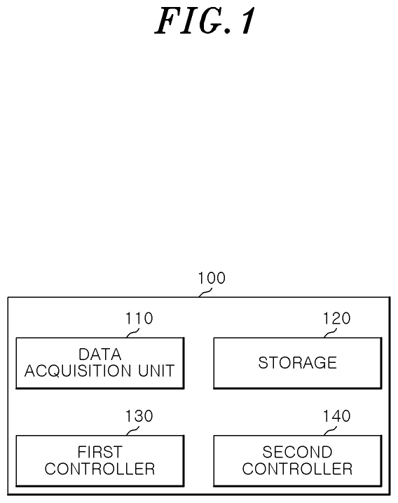

FIG. 1 is a functional block diagram of an apparatus 100 for determining the number of layers according to an embodiment of the present disclosure. Overall operations of the apparatus 100 for determining the number of layers according to an embodiment of the present disclosure may be performed by one or more processors, and the one or more processors may control functional blocks included in the apparatus shown in FIG. 1 to perform operations which will be described later.

Referring to FIG. 1, the apparatus 100 for determining the number of layers according to an embodiment of the present disclosure may include a data acquisition unit 110, a storage 120, a first controller 130, and a second controller 140.

The data acquisition unit 110 may acquire a graph data structure (hereinafter, referred to as a “graph structure”) including information between nodes. The data acquisition unit 110 may receive the graph structure from a manager or obtain the same from an external device. The data acquisition unit 110 may include an interface module for receiving the graph structure. The data acquisition unit 110 may include a wired/wireless communication module for transmitting/receiving data to/from an external device.

For example, the graph structure includes user nodes and item nodes, and the information between nodes includes purchase information indicating whether or not users of user nodes purchase items of item nodes.

The storage 120 may store the graph structure and a neural network model utilizing the graph structure. For example, the neural network model may include a graph neural network, a first reinforcement learning model, and a second reinforcement learning model. The storage 120 may store data generated by the neural network model. In the description of this specification, the “first reinforcement learning model” and the “second reinforcement learning model” will be collectively referred to as a “reinforcement learning model.”

The graph neural network according to an embodiment may include a neural network trained to derive an embedding based on information of an input node and neighboring nodes by receiving node information of the graph structure as an input. For example, the graph neural network may be trained based on a graph neural network (GNN) algorithm. According to the GNN algorithm of the graph neural network, an embedding may be derived while input node information passes through layers configured in a graph structure. The graph neural network according to the embodiment of the present disclosure can adaptively determine the number of required layers of the graph neural network according to each node included in the graph structure by being associating with a reinforcement learning model trained to determine the number of layers.

The first reinforcement learning model may determine the optimal number of layers to be applied when the graph neural network derives an embedding of each user node included in the graph structure. The second reinforcement learning model may determine the optimal number of layers to be applied by the graph neural network to derive an embedding of each item node included in the graph structure. For example, the reinforcement learning models may be trained based on a Q-Learning algorithm.

The first controller 130 may train and control the reinforcement learning models. The first controller 130 may set an environment, state, action, policy, and reward of each reinforcement learning model as in the following embodiment.

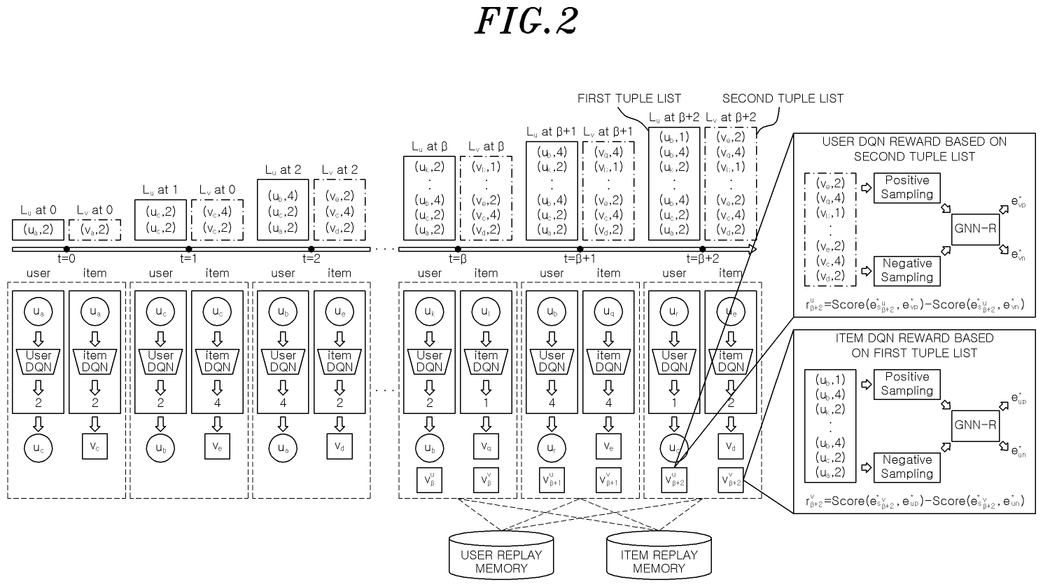

For example, the first controller 130 may set the graph structure as the “environment” of the first reinforcement learning model. The first controller 130 may set any one user node that is an observation target for reinforcement learning among user nodes included in the graph structure as a “state.” The first controller 130 may advance the observation target from the user node in the current state to the user node in the next state along the trunk line of the graph structure, and at this time, may set a “policy” that sets a user node in a state with the highest expected value for reinforcement learning rewards from the user node in the “current state” as the “next state.” In this case, an expected value may be set as the sum of rewards received from a specific node to nodes reached by branching from the specific node a predetermined number of times. According to the above policy, the first controller 130 may set the number of branches from the user node in the current state to the user node in the next state as an “action.” The first controller 130 may set the “reward” of the first reinforcement learning model such that it is set by information of item nodes, and a detailed description of the “reward” of the first reinforcement learning model will be described later with reference to FIG. 2.

For example, the first controller 130 may set the graph structure as the “environment” of the second reinforcement learning model. The first controller 130 may set any one item node that is an observation target for reinforcement learning among item nodes included in the graph structure as a “state.” The first controller 130 may advance the observation target from the item node in the current state to the item node in the next state along the trunk line of the graph structure, and at this time, may set a “policy” that sets an item node in a state with the highest expected value for reinforcement learning rewards from the item node in the “current state” as the “next state.” According to the above policy, the first controller 130 may set the number of branches from the node in the current state to the node in the next state as an “action.” The first controller 130 may set the “reward” of the second reinforcement learning model such that it is set by information of item nodes, and a detailed description of the “reward” of the second reinforcement learning model will be described later with reference to FIG. 2.

According to the design of the reinforcement learning models of the above-described embodiment, the first reinforcement learning model and the second reinforcement learning model have the same graph structure as the environments, and learning may be performed with different observation targets of “user node” and “item node” for the respective models. In addition, since the reward of each model is based on the attributes of nodes different from those of a node that is an observation target, learning can be performed in consideration of heterogeneous characteristics of user nodes and item nodes.

The second controller 140 may train and control the graph neural network designed based on the graph structure. The second controller 140 may adaptively determine the number of layers of the graph neural network based on results derived by the first reinforcement learning model and the second reinforcement learning model. For example, in determining the number of layers for extracting the embedding of a predetermined node, the second controller 140 may derive the embedding by determining the same number of layers as the number of branches output by the first reinforcement learning model or the second reinforcement learning model as an action for the corresponding node.

FIG. 2 is an exemplary diagram for describing a learning process of the first reinforcement learning model, the second reinforcement learning model, and the graph neural network according to an embodiment of the present disclosure.

Referring to FIG. 2, the first controller 130 may input node information of a current state to a reinforcement learning model and store the number of branches output as an action for the corresponding node in the storage 120. For example, the storage 120 may store input/output data of the reinforcement learning model in the form of a tuple of [node information, number of branches].

The first controller 130 may search for a node in the next state in the graph structure based on [node information, number of branches].

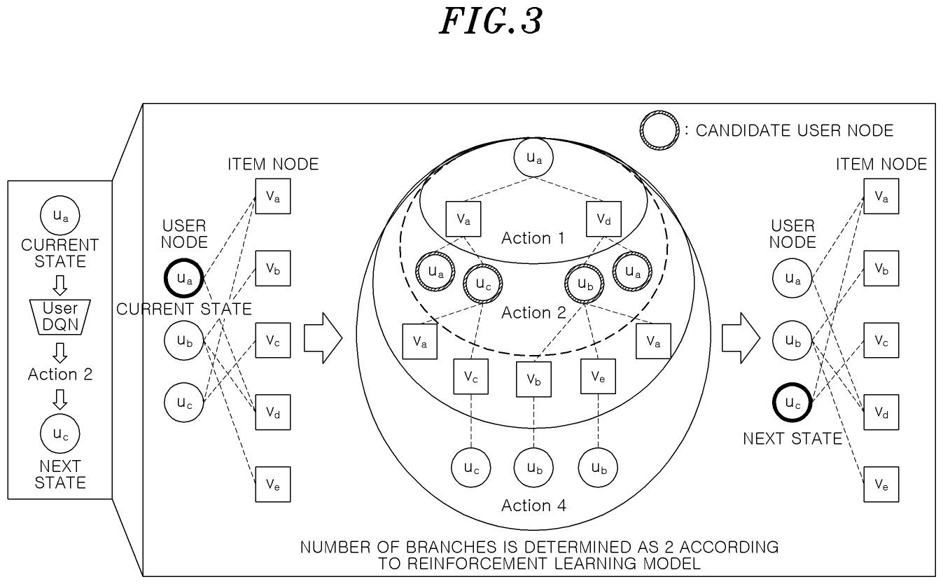

FIG. 3 is an exemplary diagram of an operation of searching for a node in a next state from a node in a current state based on the number of branches output as an action by a reinforcement learning model according to an embodiment of the present disclosure.

According to the example shown on the left side of FIG. 3, when the first reinforcement learning model User DQN receives a node uₐ in the current state and outputs the number of branches, “2”, as an action, the first controller 130 can search for a node u c in the next state based on information of [uₐ, 2].

According to the example shown on the right side of FIG. 3, the first controller 130 searches for candidate user nodes corresponding to the number of branches, “2”, in the graph structure from the node uₐ according to the information of [uₐ, 2]. That is, in the graph structure according to the example of FIG. 3, item nodes vₐ and v_{d} may be searched in the first branch connected to the user node uₐ in the current state by a trunk line, and candidate user nodes uₐ, u_{c}, u_{b}, and uₐ may be searched in the second branch connected to the item nodes vₐ and v_{d} by a trunk line. The first controller 130 may randomly select any one of the searched nodes uₐ, u_{c}, u_{b}, and uₐ according to the number of branches output as an action and designate the node u_{c} as a node in the next state. The node u_{c} becomes a node in the current state in the next round, and the above-described process of FIG. 3 may be repeatedly performed.

Although the above-described example of FIG. 3 is based on user nodes of the first reinforcement learning model, the same search operation may be performed for the second reinforcement learning model based on item nodes.

Referring back to FIG. 2, the first controller 130 may store a tuple of [node information, number of branches] generated at each round (t=0, 1, 2, . . . , β, β+1, β+2) by repeatedly performing the process of inputting node information of the current state to each of the first reinforcement learning model and the second reinforcement learning model and searching for a node in the next state according to the number of branches output as an action for the corresponding node at each round (t=0, 1, 2, . . . , β, β+1, β+2).

For example, if the aforementioned process starts from the first round and proceeds to the n-th round (n is a natural number equal to or greater than 2) by the first reinforcement learning model, the storage 120 may store a first tuple list Lᵤ including [first user node, number of first branches] to [n-th user node, number of n-th branches] based on user nodes.

For example, if the aforementioned process starts from the first round and proceeds to the n-th round (n is a natural number equal to or greater than 2) by the second reinforcement learning model, the storage 120 may store a second tuple list Lᵥ including [first item node, number of first branches] to [n-th item node, number of n-th branches] based on item nodes.

The first controller 130 may set a first reward of the first reinforcement learning model based on information of item nodes included in the second tuple list and set a second reward of the second reinforcement learning model based on information of user nodes included in the first tuple list. For example, the first controller 130 may set a reward when a predetermined amount of data or more is accumulated in a tuple list. The storage 130 may include a user replay memory and an item replay memory, store information on “current state, action, reward, next state” in a replay memory from a round (e.g., setting from t=β, β+1, β+2 in the case of FIG. 2) at which a reward is obtained, and select some of the data stored in the replay memory to set a reward of the reinforcement learning model.

For example, if a node input to the first reinforcement learning model as a current state is referred to as a “first input node”, a first reward applied to the first input node of the first reinforcement learning model may include a function for assigning a higher score as the embedding distance between a “positive node”, which has purchase information regarding the first input node among item nodes included in the second tuple list, and the “first input node” is closer and a function for deducting a higher score as the embedding distance between a “negative node”, which has no purchase information regarding the first input node among the item nodes included in the second tuple list, and the “first input node” is closer.

γ_{β+2}^{u}=Score(e*ₛ_{_{β+2}}^{u},e*ᵤₚ)−Score(e*ₛ_{_{β+2}}^{u},e*ᵥₙ) [Equation 1]

According to Equation 1, the first controller 130 may set, as the first reward γ_{β+2}^{u}, a difference between the inner product of an embedding vector e*ₛ_{_{β+2}}^{u} of the first input node and an embedding vector e*ₛ_{_{β+2}}^{u} of a positive node in the second tuple list and the inner product of the embedding vector e*ₛ_{_{β+2}}^{u} of the first input node and an embedding vector e*ᵥₙ of a negative node in the second tuple list.

In addition, if a node input to the second reinforcement learning model as a current state is referred to as a “second input node”, a second reward applied to the second input node of the second reinforcement learning model may include a function for assigning a higher score as the embedding distance between a “positive node”, which has purchase information regarding the second input node among user nodes included in the first tuple list, and the “second input node” is closer and a function for deducting a higher score as the embedding distance between a “negative node”, which has no purchase information regarding the second input node among the user nodes included in the first tuple list, and the “second input node” is closer.

γ_{β+2}^{v}=Score(e*ₛ_{_{β+2}}^{v},e*ᵤₚ)−Score(e*ₛ_{_{β+2}}^{v},e*ᵤₙ) [Equation 2]

According to Equation 2, the first controller 130 may set, as the second reward γ_{β+2}^{u}, a difference between the inner product of an embedding vector e*ₛ_{_{β+2}}^{v} of the second input node and an embedding vector e*ᵤₚ of a positive node in the first tuple list and the inner product of the embedding vector e*ₛ_{_{β+2}}^{v} of the second input node and an embedding vector e*ᵤₙ of a negative node in the first tuple list.

In extracting positive nodes and negative nodes from the first tuple list and the second tuple list, the first controller 130 may calculate the first reward and the second reward by extracting the same number of positive nodes and negative nodes.

The second controller 140 may train the graph neural network based on the first tuple list or the second tuple list after a predetermined number of rounds (t=0, 1, 2, . . . , β, β+1, β+2) of reinforcement learning is performed.

For example, when a k-th node (k is the number of rounds included in a tuple list) among the tuples included in the first tuple list or the second tuple list is used for learning, the second controller 140 may determine the same number of layers of the graph neural network as the number of k-th branches stored together in the tuple, and train the graph neural network by using an embedding that has finally passed the number of layers from the embedding of the k-th node as a final embedding of the k-th node. Accordingly, the graph neural network can adaptively determine the number of required layers of the graph neural network according to each node included in the graph structure by operating in association with the first reinforcement learning model that determines the optimal number of layers to be applied to derive the embedding of each user node and the second reinforcement learning model that determines the optimal number of layers to be applied to derive the embedding of each item node, thereby deriving the optimal embedding according to characteristics of each node.

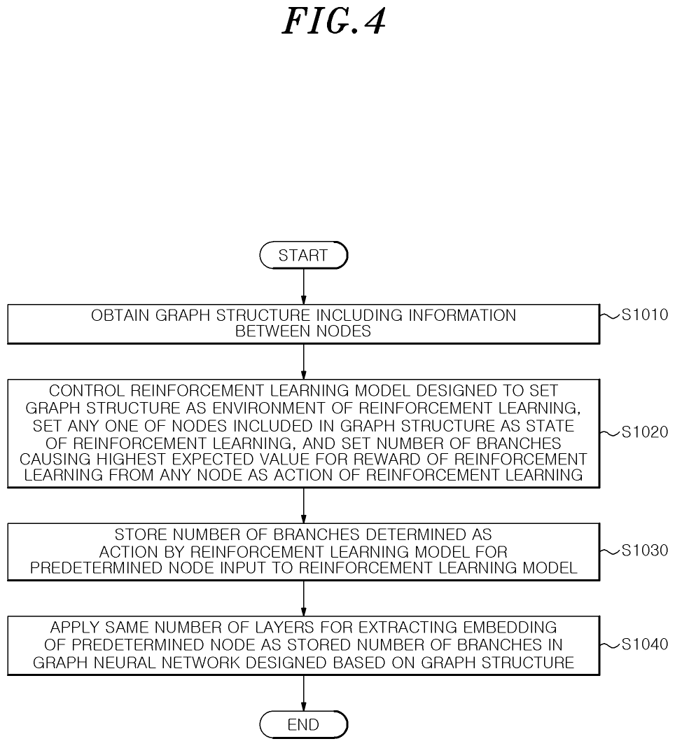

FIG. 4 is a flowchart of a method of determining the number of layers performed by the apparatus 100 for determining the number of layers according to an embodiment of the present disclosure. Each step of the method of determining the number of layers according to FIG. 4 may be performed by the apparatus 100 for determining the number of layers described with reference to FIG. 1, and each step is described as follows.

In step S1010, the data acquisition unit 110 may obtain a graph structure including information between nodes.

In step S1020, the first controller 130 may control a reinforcement learning model designed to set the graph structure as an environment of reinforcement learning, set any one of the nodes included in the graph structure as a state of reinforcement learning, and set a number of branches causing a highest expected value for a reward of reinforcement learning from any node as an action of reinforcement learning.

In step S1030, the storage 120 may store the number of branches determined by the reinforcement learning model as an action for a predetermined node input to the reinforcement learning model.

In step S1040, the second controller 140 may apply the same number of layers for extracting the embedding of a predetermined node as the number of stored branches in a graph neural network designed based on the graph structure.

Meanwhile, in addition to the steps shown in FIG. 4, a new step performed by each functional block may be added by configuring various embodiments in which the above-described data acquisition unit 110, storage 120, first controller 130, and second controller 140 perform the operations described with reference to FIG. 1 to FIG. 3. Since a configuration of additional steps and operations of components that perform each step have been described in FIG. 1 to FIG. 3, redundant descriptions are omitted.

According to the above-described embodiment, the graph neural network of the present disclosure can adaptively determine the number of required layers of the graph neural network according to each node included in the graph structure by operating in association with the first reinforcement learning model that determines the optimal number of layers to be applied to derive the embedding of each user node and the second reinforcement learning model that determines the optimal number of layers to be applied to derive the embedding of each item node, thereby deriving the optimal embedding according to characteristics of each node. Furthermore, since a reward is determined based on item information for the first reinforcement learning model for determining the number of layers of a user node, and a reward is determined based on user information for the second reinforcement learning model for determining the number of layers of an item node, learning can be performed in consideration of heterogeneous characteristics of users and items, and thus the performance can be improved beyond the limitations of a recommendation system using a graph neural network alone.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. An apparatus for determining a number of layers, the apparatus comprising:
a data manager configured to obtain a graph structure including information between nodes;
a first controller configured to control a reinforcement learning model designed to set the graph structure as an environment of reinforcement learning, set any one of nodes included in the graph structure as a state of reinforcement learning, and set a number of branches causing a highest expected value for a reward of reinforcement learning from any node as an action of reinforcement learning;
a storage configured to store the number of branches determined by the reinforcement learning model as an action for a predetermined node input to the reinforcement learning model; and
a second controller configured to apply the same number of layers for extracting an embedding of the predetermined node as the stored number of branches in a graph neural network designed based on the graph structure.

2. The apparatus of claim 1, wherein the graph structure includes user nodes and item nodes, and the information between nodes includes purchase information indicating whether or not users of user nodes purchase items of item nodes.

3. The apparatus of claim 1, wherein the graph structure includes information on users, items, and entities of a knowledge graph along with the knowledge graph.

4. The apparatus of claim 2, wherein the reinforcement learning model includes:
a first reinforcement learning model designed to set the graph structure as an environment of reinforcement learning, set any one of the user nodes as a state of reinforcement learning, and set a number of branches causing a highest expected value for a reward of reinforcement learning from any user node as an action of reinforcement learning; and
a second reinforcement learning model designed to set the graph structure as an environment of reinforcement learning, set any one of the item nodes as a state of reinforcement learning, and set a number of branches causing a highest expected value for a reward of reinforcement learning from any item node as an action of reinforcement learning.

5. The apparatus of claim 4, wherein the storage stores:
a first tuple list including an identifier corresponding to each of first to (n+1)-th user nodes based on the user nodes and the number of branches corresponding to each of the first to (n+1)-th user nodes in a case where the first reinforcement learning model extracts the number of (n+1)-th branches for the (n+1)-th user node reached from an n-th user node through branching by the number of n-th branches in the graph structure based on the n-th user node (n being a natural number) input to the first reinforcement learning model and the number of n-th branches determined by the first reinforcement learning model for the n-th user node; and
a second tuple list including an identifier corresponding to each of first to (n+1)-th item nodes based on the item nodes and the number of branches corresponding to each of the first to (n+1)-th item nodes in a case where the second reinforcement learning model extracts the number of (n+1)-th branches for the (n+1)-th item node reached from an n-th item node through branching by the number of n-th branches in the graph structure based on the n-th item node (n being a natural number) input to the second reinforcement learning model and the number of n-th branches determined by the second reinforcement learning model for the n-th item node.

6. The apparatus of claim 5, wherein the first controller sets a first reward of the first reinforcement learning model based on information on item nodes included in the second tuple list and sets a second reward of the second reinforcement learning model based on information on user nodes included in the first tuple list.

7. The apparatus of claim 6, wherein the first reward applied to a first input node of the first reinforcement learning model includes a function for assigning a higher score as an embedding distance between a positive node, which has purchase information regarding the first input node among the item nodes included in the second tuple list, and the first input node is closer and a function for deducting a higher score as an embedding distance between a negative node, which has no purchase information regarding the first input node among the item nodes included in the second tuple list, and the first input node is closer, and
wherein the second reward applied to a second input node of the second reinforcement learning model includes a function for assigning a higher score as an embedding distance between a positive node, which has purchase information regarding the second input node among the user nodes included in the first tuple list, and the second input node is closer and a function for deducting a higher score as an embedding distance between a negative node, which has no purchase information regarding the second input node among the user nodes included in the first tuple list, and the second input node is closer.

8. The apparatus of claim 7, wherein the first controller sets, as the first reward, a difference between an inner product of an embedding vector of the first input node and an embedding vector of a positive node in the second tuple list and an inner product of the embedding vector of the first input node and an embedding vector of a negative node in the second tuple list, and sets, as the second reward, a difference between an inner product of an embedding vector of the second input node and an embedding vector of a positive node in the first tuple list and an inner product of the embedding vector of the second input node and an embedding vector of a negative node in the first tuple list.

9. The apparatus of claim 7, wherein the first controller sets the first reward by sampling the same number of positive nodes and negative nodes in the second tuple list, and sets the second reward by sampling the same number of positive nodes and negative nodes in the first tuple list.

10. The apparatus of claim 5, wherein the second controller trains the graph neural network based on the first tuple list or the second tuple list by setting the same number of layers of the graph neural network as the number of k-th branches when a k-th node (k being a natural number equal to or greater than 1 and equal to or less than n+1) among tuples included in the first tuple list or the second tuple list is used for learning, and using an embedding that has finally passed the number of layers from the k-th node as a final embedding of the k-th node.

11. A method of determining a number of layers, performed by an apparatus for determining a number of layers, the method comprising:
obtaining a graph structure including information between nodes;
controlling a reinforcement learning model designed to set the graph structure as an environment of reinforcement learning, set any one of nodes included in the graph structure as a state of reinforcement learning, and set a number of branches causing a highest expected value for a reward of reinforcement learning from any node as an action of reinforcement learning;
storing the number of branches determined by the reinforcement learning model as an action for a predetermined node input to the reinforcement learning model; and
applying the same number of layers for extracting an embedding of the predetermined node as the stored number of branches in a graph neural network designed based on the graph structure.

12. The method of claim 11, wherein the graph structure includes user nodes and item nodes, and the information between nodes includes purchase information indicating whether or not users of user nodes purchase items of item nodes.

13. The method of claim 12, wherein the reinforcement learning model includes:
a first reinforcement learning model designed to set the graph structure as an environment of reinforcement learning, set any one of the user nodes as a state of reinforcement learning, and set a number of branches causing a highest expected value for a reward of reinforcement learning from any user node as an action of reinforcement learning; and
a second reinforcement learning model designed to set the graph structure as an environment of reinforcement learning, set any one of the item nodes as a state of reinforcement learning, and set a number of branches causing a highest expected value for a reward of reinforcement learning from any item node as an action of reinforcement learning.

14. The method of claim 13, wherein the storing comprises:
storing a first tuple list including an identifier corresponding to each of first to (n+1)-th user nodes based on the user nodes and the number of branches corresponding to each of the first to (n+1)-th user nodes in a case where the first reinforcement learning model extracts the number of (n+1)-th branches for the (n+1)-th user node reached from an n-th user node through branching by the number of n-th branches in the graph structure based on the n-th user node (n being a natural number) input to the first reinforcement learning model and the number of n-th branches determined by the first reinforcement learning model for the n-th user node; and
storing a second tuple list including an identifier corresponding to each of first to (n+1)-th item nodes based on the item nodes and the number of branches corresponding to each of the first to (n+1)-th item nodes in a case where the second reinforcement learning model extracts the number of (n+1)-th branches for the (n+1)-th item node reached from an n-th item node through branching by the number of n-th branches in the graph structure based on the n-th item node (n being a natural number) input to the second reinforcement learning model and the number of n-th branches determined by the second reinforcement learning model for the n-th item node.

15. The method of claim 14, wherein the controlling comprises:
setting a first reward of the first reinforcement learning model based on information on item nodes included in the second tuple list; and
setting a second reward of the second reinforcement learning model based on information on user nodes included in the first tuple list.

16. The method of claim 15, wherein the first reward applied to a first input node of the first reinforcement learning model includes a function for assigning a higher score as an embedding distance between a positive node, which has purchase information regarding the first input node among the item nodes included in the second tuple list, and the first input node is closer and a function for deducting a higher score as an embedding distance between a negative node, which has no purchase information regarding the first input node among the item nodes included in the second tuple list, and the first input node is closer, and
wherein the second reward applied to a second input node of the second reinforcement learning model includes a function for assigning a higher score as an embedding distance between a positive node, which has purchase information regarding the second input node among the user nodes included in the first tuple list, and the second input node is closer and a function for deducting a higher score as an embedding distance between a negative node, which has no purchase information regarding the second input node among the user nodes included in the first tuple list, and the second input node is closer.

17. The method of claim 16, wherein the controlling comprises:
setting, as the first reward, a difference between an inner product of an embedding vector of the first input node and an embedding vector of a positive node in the second tuple list and an inner product of the embedding vector of the first input node and an embedding vector of a negative node in the second tuple list; and
setting, as the second reward, a difference between an inner product of an embedding vector of the second input node and an embedding vector of a positive node in the first tuple list and an inner product of the embedding vector of the second input node and an embedding vector of a negative node in the first tuple list.

18. The method of claim 16, wherein the controlling comprises:
setting the first reward by sampling the same number of positive nodes and negative nodes in the second tuple list; and
setting the second reward by sampling the same number of positive nodes and negative nodes in the first tuple list.

19. The method of claim 14, wherein the applying comprises training the graph neural network based on the first tuple list or the second tuple list by setting the same number of layers of the graph neural network as the number of k-th branches when a k-th node (k being a natural number equal to or greater than 1 and equal to or less than n+1) among tuples included in the first tuple list or the second tuple list is used for learning, and using an embedding that has finally passed the number of layers from the k-th node as a final embedding of the k-th node.

20. A non-transitory computer-readable recording medium storing computer executable instructions, wherein the instructions, when executed by a processor, cause the processor to perform a method of determining a number of layers, the method comprising:
obtaining a graph structure including information between nodes;
controlling a reinforcement learning model designed to set the graph structure as an environment of reinforcement learning, set any one of nodes included in the graph structure as a state of reinforcement learning, and set a number of branches causing a highest expected value for a reward of reinforcement learning from any node as an action of reinforcement learning;
storing the number of branches determined by the reinforcement learning model as an action for a predetermined node input to the reinforcement learning model; and
applying the same number of layers for extracting an embedding of the predetermined node as the stored number of branches in a graph neural network designed based on the graph structure.
